(19) United States
(12) Patent Application Publication
(10) Pub. No.: US 2023/0100858 A1
(43) Pub. Date: Mar. 30, 2023

(54) VEHICLE CONTROL APPARATUS, VEHICLE CONTROL METHOD, AND VEHICLE CONTROL SYSTEM

(71) Applicant: Hitachi Astemo, Ltd., Hitachinaka-shi, Ibaraki (JP)

(72) Inventors: Ryusuke HIRAO, Hitachinaka-shi, Ibaraki (JP); Nobuyuki ICHIMARU, Hitachinaka-shi, Ibaraki (JP)

(21) Appl. No.: 17/911,244

(22) PCT Filed: Mar. 5, 2021
(86) PCT No.: PCT/JP2021/008663

§ 371 Date: Sep. 13, 2022

(30) Foreign Application Priority Data
Mar. 18, 2020 (JP) 2020-047947

(51) Int. Cl. B60G 17/018; G06N 3/08

(52) U.S. Cl. CPC B60G 17/018; G06N 3/08; B60G 2400/102

(57) ABSTRACT

A controller includes a calculation processing portion configured to make a predetermined calculation based on an input vehicle state amount and output a target damping force, and a damping force map configured to acquire a control instruction value for controlling a variable damper based on the target damping force. The calculation processing portion makes the calculation using a learning result that is acquired by causing the calculation processing portion to learn pairs of a plurality of target amounts acquired using a predetermined evaluation method prepared in advance with respect to a plurality of different vehicle state amounts as pairs of pieces of input and output data.

### TECHNICAL FIELD

The present invention relates to a vehicle control apparatus, a vehicle control method, and a vehicle control system.

### BACKGROUND ART

PTL 1 discloses that a difference is calculated between a time derivative of entropy inside a shock absorber and a time derivative of entropy provided from a control apparatus controlling the shock absorber to the shock absorber, and a control parameter of the above-described control apparatus is optimized based on a genetic algorithm using this difference as an evaluation function, to optimally control the shock absorber having a non-linear motion characteristic.

### CITATION LIST

### Patent Literature

PTL 1: Japanese Patent Application Public Disclosure No. 2000-207002

### SUMMARY OF INVENTION

### Technical Problem

Then, the control of the damping force of a suspension is required to react so as to change the weight of the evaluation function and the damping force characteristic according to the preference of a driver (an operator) and/or the required specifications in actual use. This raises the necessity of studying an improvement idea to readily satisfy this requirement.

### Solution to Problem

An object of one aspect of the present invention is to provide a vehicle control apparatus, a vehicle control method, and a vehicle control system capable of changing a damping force characteristic according to a driver's preference and/or required specifications.

One aspect of the present invention is a vehicle control apparatus employed for a vehicle including a force generation mechanism configured to adjust a force between a vehicle body of the vehicle and a wheel of the vehicle. The vehicle control apparatus includes a calculation processing portion configured to make a predetermined calculation based on an input vehicle state amount and output a target amount, and a control instruction value acquisition portion configured to acquire a control instruction value for controlling the force generation mechanism based on the target amount. The calculation processing portion makes the calculation using a learning result that is acquired by causing the calculation processing portion to learn pairs of a plurality of target amounts acquired using a predetermined evaluation method prepared in advance with respect to a plurality of different vehicle state amounts as pairs of pieces of input and output data.

One aspect of the present invention is a vehicle control method employed for a vehicle including a force generation mechanism configured to adjust a force between a vehicle body of the vehicle and a wheel of the vehicle. The vehicle control method includes a calculation processing step of making a predetermined calculation based on an input vehicle state amount and outputting a target amount, and a control instruction value acquisition step of acquiring a control instruction value for controlling the force generation mechanism based on the target amount. The calculation processing step includes making the calculation using a learning result that is acquired by causing a calculation processing portion to learn pairs of a plurality of target amounts acquired using a predetermined evaluation method prepared in advance with respect to a plurality of different vehicle state amounts as pairs of pieces of input and output data.

One aspect of the present invention is a vehicle control system including a force generation mechanism configured to adjust a force between a vehicle body of a vehicle and a wheel of the vehicle, and a controller. The controller includes a calculation processing portion configured to make a predetermined calculation based on an input vehicle state amount and output a target amount, and a control instruction value acquisition portion configured to acquire a control instruction value for controlling the force generation mechanism based on the target amount. The calculation processing portion is configured to make the calculation using a learning result that is acquired by causing the calculation processing portion to learn pairs of a plurality of target amounts acquired using a predetermined evaluation method prepared in advance with respect to a plurality of different vehicle state amounts as pairs of pieces of input and output data.

According to the aspects of the present invention, the damping force characteristic can be changed according to the driver's preference and/or the required specifications.

### BRIEF DESCRIPTION OF DRAWINGS

FIG. 1 schematically illustrates a vehicle control system according to a first embodiment.

FIG. 2 illustrates a procedure of training a DNN of a controller according to the first embodiment and a third embodiment.

FIG. 3 illustrates specific examples of a first map and a second map included in a weight coefficient calculation map.

FIG. 4 illustrates characteristic lines indicating changes in a road surface displacement, a sprung acceleration, a sprung jerk, a piston speed, a current value, and a damping force over time with respect to the first embodiment and a comparison example.

FIG. 5 illustrates a vehicle control system according to a second embodiment.

FIG. 6 illustrates a vehicle control system according to a fourth embodiment.

### DESCRIPTION OF EMBODIMENTS

In the following description, a vehicle control apparatus, a vehicle control method, and a vehicle control system according to embodiments of the present invention will be described in detail with reference to the accompanying drawings, citing an example in which they are applied to a four-wheeled automobile.

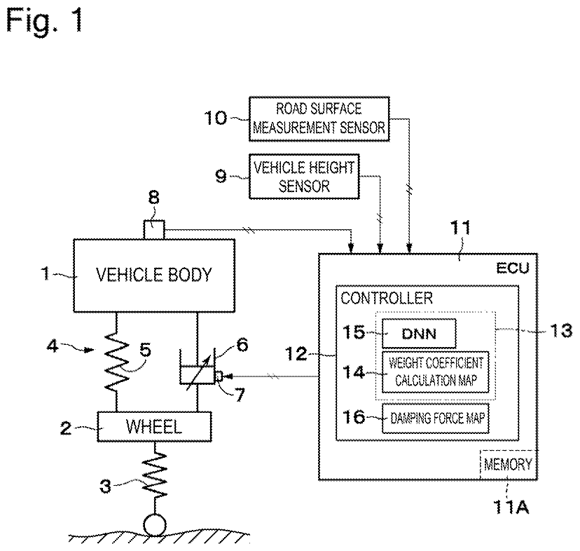

In FIG. 1, for example, left and right front wheels and left and right rear wheels (hereinafter collectively referred to as wheels 2) are mounted under a vehicle body 1, which forms a main structure of a vehicle. These wheels 2 each include a tire 3. The tire 3 functions as a spring that absorbs fine roughness of a road surface.

A suspension apparatus 4 is provided so as to be interposed between the vehicle body 1 and the wheel 2. The suspension apparatus 4 includes a suspension spring 5 (hereinafter referred to as a spring 5), and a damping force adjustable shock absorber (hereinafter referred to as a variable damper 6), which is provided so as to be arranged in a parallel relationship with the spring 5 and interposed between the vehicle body 1 and the wheel 2. FIG. 1 schematically illustrates the configuration in the case where one set of suspension apparatus 4 is provided between the vehicle body 1 and the wheel 2. In the case of a four-wheeled automobile, the suspension apparatus 4 is mounted in such a manner that four sets in total are provided individually independently between the four wheels 2 and the vehicle body 1.

Now, the variable damper 6 of the suspension apparatus 4 is a force generation mechanism that generates an adjustable force between the vehicle body 1 side and the wheel 2 side. The variable damper 6 is formed using a damping force adjustable hydraulic shock absorber. The damper 6 is equipped with a damping force variable actuator 7 formed by a damping force adjustment valve or the like for adjusting the characteristic of a generated damping force (i.e., a damping force characteristic) continuously from a hard characteristic (a high characteristic) to a soft characteristic (a low characteristic). The damping force variable actuator 7 does not necessarily have to be configured to continuously adjust the damping force characteristic, and may be configured to be able to adjust the damping force through, for example, a plurality of steps equal to or more than two steps. Further, the variable damper 6 may be a pressure control-type damper or may be a flow rate control-type damper.

A sprung acceleration sensor 8 detects the vertical acceleration of the vehicle body 1 (the sprung side). The sprung acceleration sensor 8 is provided at any position of the vehicle body 1. The sprung acceleration sensor 8 is mounted on the vehicle body 1 at, for example, a position near the variable absorber 6. The sprung acceleration sensor 8 detects the acceleration of a vertical vibration on the vehicle body 1 side corresponding to the so-called sprung side, and outputs a detection signal thereof to an electronic control unit 11 (hereinafter referred to as an ECU 11).

A vehicle height sensor 9 detects the height of the vehicle body 1. As the vehicle height sensor 9, a plurality of (for example, four) vehicle height sensors is provided on, for example, the vehicle body 1 side corresponding to the sprung side in correspondence with the wheels 2, respectively. In other words, each of the vehicle height sensors 9 detects the position of the vehicle body 1 relative to each of the wheels 2 (the height position) and outputs a detection signal thereof to the ECU 11. The vehicle height sensor 9 and the sprung acceleration sensor 8 form a vehicle state amount acquisition portion that detects a vehicle state amount. The vehicle state amount is not limited to the vertical acceleration of the vehicle body 1 and the height of the vehicle body 1. The vehicle state amount may include, for example, a relative speed acquired by differentiating the height of the vehicle body 1 (the vehicle height) and a vertical speed acquired by integrating the vertical acceleration of the vehicle body 1. In this case, the vehicle state amount acquisition portion also includes, for example, a differentiator that differentiates the vehicle height and an integrator that integrates the vertical acceleration in addition to the vehicle height sensor 9 and the sprung acceleration sensor 8.

A road surface measurement sensor 10 forms a road surface profile acquisition portion that detects a road surface profile as road surface information. The road surface measurement sensor 10 is formed by, for example, a plurality of millimeter-wave radars. The road surface measurement sensor 10 measures and detects the state of a road surface lying ahead of the vehicle (more specifically, including the distance and the angle to the road surface targeted for the detection, and the screen position and the distance). The road surface measurement sensor 10 outputs the road surface profile based on a detection value of the mad surface.

The road surface measurement sensor 10 may be, for example, a combination of a millimeter-wave radar and a monocular camera, or may be formed by a stereo camera including a pair of left and right image sensors (for example, digital cameras) as discussed in, for example. Japanese Patent Application Public Disclosure No. 2011-138244. The road surface measurement sensor 10 may be formed by an ultrasonic distance sensor or the like.

The ECU 11 is mounted on the vehicle body 1 side of the vehicle as a control apparatus in charge of behavior control including, for example, posture control of the vehicle. The ECU 11 is formed using, for example, a microcomputer. The ECU 11 includes a memory 11A capable of storing data therein. The ECU 11 includes a controller 12.

The input side of the ECU 11 is connected to the sprung acceleration sensor 8, the vehicle height sensor 9, the road surface measurement sensor 10, and a mode switch 17. The output side of the ECU 11 is connected to the damping force variable actuator 7 of the variable damper 6. The controller 12 of the ECU 11 acquires the road surface profile and the vehicle state amount based on the detection value of the vertical vibration acceleration by the sprung acceleration sensor 8, the detection value of the vehicle height of the vehicle height sensor 9, and the detection value of the road surface by the road surface measurement sensor 10. The controller 12 calculates a force that should be generated by the variable damper 6 (a force generation mechanism) of the suspension apparatus 4 based on the road surface profile and the vehicle state amount, and outputs an instruction signal thereof to the damping force variable actuator 7 of the suspension apparatus 4.

The ECU 11 stores the data of the vehicle state amount and the road surface input into the memory 11A for, for example, several seconds during which the vehicle runs by approximately 10 to 20 m. As a result, the ECU 11 generates chronological data of the road surface input (the road surface profile) and chronological data of the vehicle state amount when the vehicle runs by a predetermined running distance. The controller 12 performs control so as to adjust the damping force that should be generated by the variable damper 6 based on the chronological data of the road surface profile and the vehicle state amount.

The controller 12 includes a calculation processing portion 13 and a damping force map 16. The calculation processing portion 13 makes a predetermined calculation based on the input vehicle state amount and outputs a target damping force serving as a target amount. The calculation processing portion 13 makes the calculation using a learning result that is acquired by causing the calculation processing portion 13 (a DNN 15) (a deep neural network) to learn pairs of a plurality of target damping forces acquired using a predetermined evaluation method (an evaluation function J) prepared in advance with respect to a plurality of different vehicle state amounts as pairs of pieces of input and output data. At this time, the calculation processing portion 13 makes the calculation while additionally taking the input road surface information (the road surface profile) into consideration. To achieve that, the calculation processing portion 13 makes the calculation using a learning result that is acquired by causing the calculation processing portion 13 to learn pairs of a plurality of target damping forces acquired using the predetermined evaluation method (the evaluation function J) prepared in advance with respect to the plurality of different vehicle state amounts and a plurality of different pieces of road surface information as pairs of pieces of input and output data. The calculation processing portion 13 includes a weight coefficient calculation map 14 and the already trained DNN 15. In this case, the learning result is weight coefficients Wij acquired by deep learning, which uses a neural network for the learning.

A plurality of pairs of different weight coefficients Wij_HighGain and Wij_LowGain, which is acquired by applying the deep learning using a plurality of different weights (weights of the evaluation function J), is set to the weight coefficient calculation map 14. The weight coefficient calculation map 14 acquires a single pair of weight coefficients Wij specified based on the plurality of pairs of different weight coefficients Wij_HighGain and Wij_LowGain according to an input predetermined condition.

The mode switch 17 is connected to the input side of the weight coefficient calculation map 14. The mode switch 17 is provided on the vehicle body 1. The mode switch 17 includes, for example, three modes, namely. “Sport”. “Normal”, and “Comfort”. The mode switch 17 selects one mode among these three modes. The mode switch 17 outputs a signal of the selected mode to the weight coefficient calculation map 14 of the ECU 11. In this case, the predetermined condition input to the weight coefficient calculation map 14 is the mode selected by the mode switch 17.

The plurality of pairs (for example, two pairs) of already learned weight coefficients Wij_HighGain and Wij_LowGain is set to the weight coefficient calculation map 14. The weight coefficient calculation map 14 calculates a new single pair of weight coefficients Wij by combining this plurality of pairs of weight coefficients Wij_HighGain and Wij_LowGain according to the mode selected by the mode switch 17. The weight coefficient calculation map 14 sets the calculated single pair of weight coefficients Wij to the DNN 15.

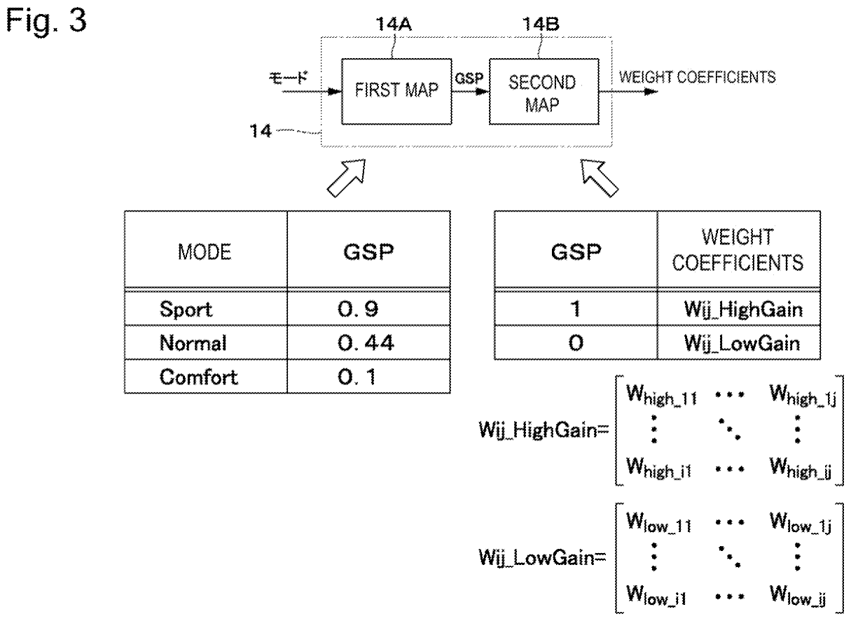

As illustrated in FIG. 3, the weight coefficient calculation map 14 includes a first map 14A and a second map 14B. The first map 14A is a mode SW-GSP map indicating the relationship between the mode output from the mode switch 17 and a gain scheduling parameter (GSP). The first map 14A calculates the GSP according to the mode selected by the mode switch 17. For example, the GSP is calculated to be 0.9 in the “Sport” mode. The GSP is calculated to be 0.44 in the “Normal” mode. The GSP is calculated to be 0.1 in the “Comfort” mode.

The second map 14B is a GSP-weight coefficient map indicating the relationship between the weight coefficients and the GSP. The second map 14B calculates the new single pair of weight coefficients Wij by combining the preset plurality of pairs (for example, two pairs) of weight coefficients Wij_HighGain and Wij_LowGain according to the GSP output from the first map 14A. For example, the first pair of weight coefficients Wij_HighGain includes weight coefficients Whigh_11, . . . , and Whigh_ij, and corresponds to when the GSP is calculated to be 1. On the other hand, the second pair of weight coefficients Wij_LowGain includes weight coefficients Wlow_11, . . . , and Wlow_ij, and corresponds to when the GSP is calculated to be 0. Therefore, the second map 14B calculates the new single pair of weight coefficients Wij by, for example, applying a linear interpolation to these two pairs of weight coefficients Wij_HighGain and Wij_LowGain based on the GSP output from the first map 14A. The second map 14B sets the calculated single pair of weight coefficients Wij to the DNN 15.

The method for interpolating the weight coefficients is not limited to the linear interpolation, and various kinds of interpolation methods can be employed. The weight coefficient calculation map 14 is not limited to the configuration including the two maps (the first map 14A and the second map 14B), and may include a single map. In this case, the weight coefficient calculation map specifies the new single pair of weight coefficients Wij by combining the plurality of pairs of weight coefficients Wij_HighGain and Wij_LowGain according to the mode.

The DNN 15 is an instruction value acquisition portion that makes the calculation using the neural network with the specific weight coefficients Wij set thereto. The controller 12 acquires the chronological data of the road surface input (the road surface profile) and the chronological data of the vehicle state amount based on the detection value of the vertical vibration acceleration by the sprung acceleration sensor 8, the detection value of the vehicle height by the vehicle height sensor 9, and the detection value of the road surface by the road surface measurement sensor 10. The DNN 15 of the controller 12 outputs chronological data of the target damping force serving as the target amount based on the chronological data of the road surface input and the chronological data of the vehicle state amount. At this time, the latest target damping force corresponds to a target damping force optimal at the present moment (an optimal target damping force).

The damping force map 16 is a control instruction value acquisition portion that acquires a control instruction value for controlling the variable damper 6 (the force generation mechanism) based on the target damping force (the target amount). The damping force map 16 indicates the relationship between the target damping force and the instruction value output to the variable damper 6. The damping force map 16 outputs an instruction value for the damping force based on the latest target damping force acquired from the DNN 15 and the relative speed between the sprung side and the unsprung side, which is included in the vehicle state amount. Due to this configuration, the controller 12 outputs the most appropriate instruction value for the damping force for the present vehicle and road surface. The instruction value for the damping force corresponds to, for example, a current value for driving the damping force variable actuator 7.

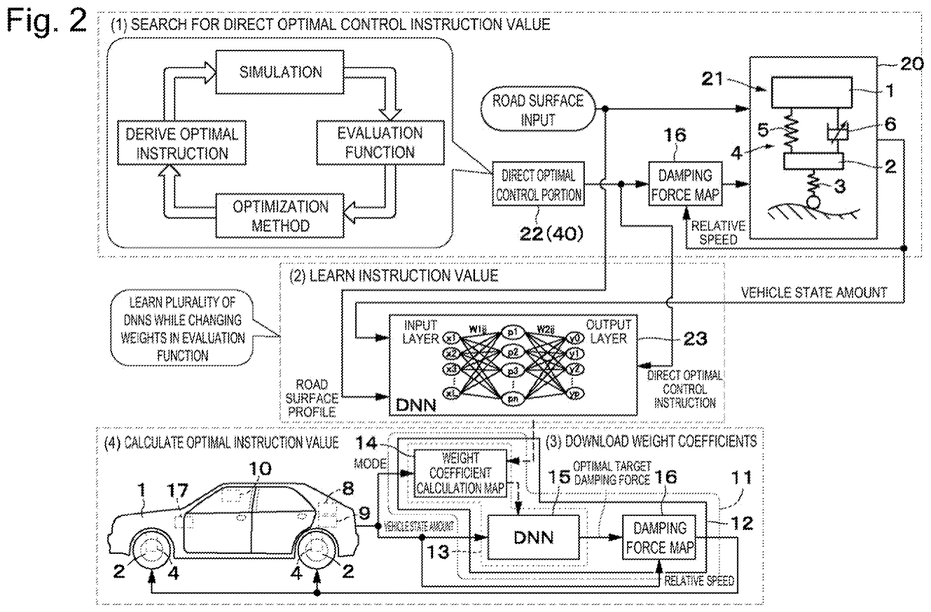

Next, the method for training the DNN 15 of the controller 12 will be described with reference to the illustrative diagram illustrated in FIG. 2. The DNN 15 is constructed by (1) searching for a direct optimal control instruction value. (2) learning the instruction value, (3) downloading the weight coefficients, and (4) calculating and setting the weight coefficients.

First, an analytical model 20 including a vehicle model 21 is constructed to search for the direct optimal control instruction value. FIG. 2 illustrates an example in a case where the vehicle model 21 is a one-wheel model. The vehicle model 21 may be, for example, a model of a pair of left and right two wheels or may be a four-wheel model. The road surface input and the optimal instruction value (the optimal target damping force) from a direct optimal control portion 22 are input to the vehicle model 21. The direct optimal control portion 22 calculates the optimal instruction value according to the following procedure for searching for the direct optimal control instruction value.

(1) Search for Direct Optimum Control Instruction Value

The direct optimal control portion 22 searches for the optimal instruction value by an iterative calculation using the analytical model 20 including the vehicle model 21 in advance. The search for the optimal instruction value is formulated as the following optimal control problem, and the optimal instruction value is calculated numerically analytically using the optimization method.

Assume that the motion of the targeted vehicle is expressed by an equation 1 in the form of an equation of state. Then, a dot in the equation represents a first-order differential with respect to time t (d/dt).

x(t)−f{x(t),u(t)} [Equation 1]

In the equation 1, x and u represent the state amount and a control input, respectively. The initial condition of the equation of state is provided as indicated by an equation 2.

x(t₀)−x₀ [Equation 2]

A constraint equation and a constraint inequality imposed from an initial time t0 to a final time tf are expressed as indicated by an equation 3 and an equation 4, respectively.

Ψ=Ψ{x(t),U(t)}=0 [Equation 3]

θ=θ{x(t),u(t)}≤0 [Equation 4]

The optimal control problem is a problem for seeking such a control input u(t) that the evaluation function J expressed as an equation 5 is minimized while the equation of state expressed as the equation 1, the initial condition expressed as the equation 2, and the constraints expressed as the equation 3 and the equation 4 are satisfied.

J=∫ₜ_{₀}^{t}^{_{f}}ϕ{x(t),u(t)}dₜ=0 [Equation 5]

It is extremely difficult to solve the optimal control problem subjected to the constraints in the above-described manner. Therefore, a direct method capable of simply handling the constraints is used as the optimization method. This method is a method that converts the optimal control problem into a parameter optimization problem and acquires a solution using the optimization method.

The period from the initial time t0 to the final time tf is divided into N sections to convert the optimal control problem into the parameter optimization problem. Assuming that t1, t2, . . . , and tN represent the respective final times of the sections, the relationship among them is expressed as indicated by an equation 6.

t₀<t₁<t₂< . . . <t_{N-1}<t_{N}−t₁ [Equation 6]

Continuous inputs u(t) can be replaced with discrete values ui at the respective final times of the sections as indicated by an equation 7.

u₁=u(t₁), (i=0,1, . . . ,N) [Equation 7]

State amounts x1, x2, . . . and xN at the respective final times of the sections are calculated by numerically integrating the equation of state with respect to the inputs u0, u1, . . . and uN under the initial condition x0. At this time, an input in each section is acquired by applying a linear interpolation on the input provided at the final time of each section. As a result thereof, the state amount is determined with respect to the input, and the evaluation function and the constraints are expressed according thereto. Therefore, the converted parameter optimization problem can be expressed in the following manner.

Assuming that X collectively represents the parameters that should be optimized. X is expressed as indicated by an equation 8.

X=[u₀^{T}. . . u_{N}^{T}]^{T} [Equation 8]

Therefore, the evaluation function indicated by the equation 5 is expressed as indicated by an equation 9.

J=Φ(X) [Equation 9]

Further, the constraints indicated by the equation 3 and the equation 4 are expressed as indicated by an equation 10 and an equation 11, respectively.

Ψ(X)=[Ψ₀^{T}Ψ₁^{T} . . . Ψ_{N}^{T}]^{T}=0 [Equation 10]

Θ(X)=[θ₀^{T}θ₁^{T} . . . θ_{N}^{T}]^{T}<0 [Equation 11]

In this manner, the optimal control problem expressed as described above can be converted into the parameter optimization problem expressed as the equation 8 to the equation 11.

The evaluation function J formulated as the optimal control problem for seeking the optimal control instruction according to the road surface is defined as indicated by an equation 12 so as to minimize the vertical acceleration Az to thus improve ride comfort and also reduce the control instruction u. In the equation 12, q1 and q2 are weights in the evaluation function. The weights q1 and q2 are preset according to, for example, a result of an experiment.

J=∫₀^{t}^{_{f}}(q₁Az²+q₂u²)dₜ

The direct optimal control portion 22 numerically analytically solves the parameter optimization problem formulated in this manner by the optimization method, thereby deriving the optimal instruction value (the target damping force) on various road surfaces.

Next, the optimal instruction value when the values of the weights q1 and q2 are changed is also derived on various road surfaces to allow the controller to be easily changed at the time of adaptation on the vehicle. For example, an increase in the weight q1 can place emphasis on the vibration damping performance so as to reduce the acceleration.

Conversely, an increase in the weight q2 leads to a reduction in the instruction value, thereby placing emphasis on the vibration isolation performance for a semi-active suspension.

(2) Learn Instruction Value

A DNN 23, which is formed by artificial intelligence, is caused to learn inputs and outputs on various road surfaces while the optimal instruction value (the target damping force) derived from the search for the direct optimal control instruction value is treated as the output and the road surface profile and the vehicle state amount at this time are treated as the input. The DNN 23 is a deep neural network for learning, and is configured similarly to the in-vehicle DNN 15. The chronological data of the road surface input as the road surface profile and the chronological data of the vehicle state amount are input to the DNN 23. At this time, weight coefficients between neurons in the DNN 23 are acquired while the chronological data of the optimal instruction value is treated as teacher data in correspondence with the road surface input and the vehicle state amount. At this time, the weight coefficients between neurons are acquired with respect to a plurality of cases in which the weights q1 and q2 of the evaluation function are different.

(3) Download Weight Coefficients

A plurality of pairs of weight coefficients Wij_HighGain and Wij_LowGain of the DNN 23 learned by the learning of the instruction value is set to the weight coefficient calculation map 14 of the actual ECU 11.

(4) Calculate Optimal Instruction Value

The controller 12 including the DNN 15 is mounted on the vehicle. The sprung acceleration sensor 8, the vehicle height sensor 9, the road surface measurement sensor 10, and the mode switch 17 are connected to the input side of the controller 12. The damping force variable actuator 7 of the variable damper 6 is connected to the output side of the controller 12. The weight coefficient calculation map 14 of the controller 12 calculates a single pair of weight coefficients Wij based on the plurality of pairs of weight coefficients Wij_HighGain and Wij_LowGain downloaded in advance according to the mode selected by the mode switch 17. The weight coefficient calculation map 14 sets the single pair of weight coefficients Wij according to the mode of the mode switch 17 to the DNN 15, which corresponds to the instruction value acquisition portion. In this manner, the DNN IS of the controller 12 is constructed.

The controller 12 acquires the road surface input and the vehicle state amount based on the signals detected by the sprung acceleration sensor 8, the vehicle height sensor 9, and the road surface measurement sensor 10. The controller 12 inputs the chronological data of the road surface input as the road surface profile and the chronological data of the vehicle state amount to the DNN 15. The DNN 15 outputs the target damping force serving as the optimal instruction according to the learning result when the chronological data of the road surface input and the vehicle state amount is input thereto. The damping force map 16 calculates the instruction value (the instruction current) based on the target damping force output from the DNN 15 and the relative speed between the sprung side and the unsprung side, which is included in the vehicle state amount. The controller 12 outputs the instruction current calculated by the damping force map 16 to the variable damper 6.

In this manner, the direct optimal control portion 22 derives the direct optimal control instruction by the off-line optimization of the numerical value under various conditions. The artificial intelligence (the DNN 23) is caused to learn the road surface profile and the vehicle state amount, and the optimal instruction at this time. As a result, the direction optimal control can be realized by the controller 12 (the ECU 11) with the DNN 15 mounted thereon without requiring optimization step by step.

Next, the ride comfort performance and the like were compared by a simulation of the vehicle with respect to feedback control based on the conventional skyhook control law as control according to a comparison example and the control by the DNN 15 according to the first embodiment to confirm the effect of the ride comfort performance due to the DNN 15. For example, the vehicle specifications assuming that this vehicle was a sedan car belonging to the E-segment were set as the simulation conditions. A ¼ vehicle model in consideration of the sprung and unsprung masses was used as the simulation model. A wavy road was set as the road surface to confirm the basic sprung vibration damping performance. The mode selected by the mode switch 17 was assumed to be the “Normal” mode.

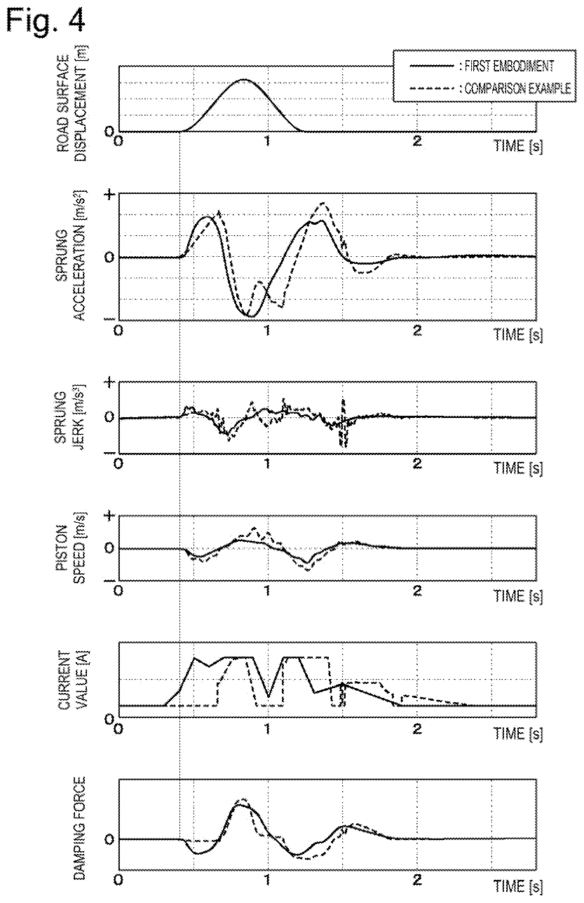

The simulation result is indicated in FIG. 4. FIG. 4 illustrates the result of changes in the sprung acceleration and the like overtime. As understood therefrom, a high damping force was set since just before the road surface input changed in the control according to the first embodiment compared to the conventional control (the skyhook control law). This reveals that, although the acceleration was high until around 0.6 seconds, the acceleration had a small peak value and also exhibited a smooth waveform and the convergence after the vehicle passed through the wavy road was also improved after that in the control according to the first embodiment compared to the control according to the comparison example (the skyhook control law). This reveals that the control according to the first embodiment was able to realize a high vibration damping performance and smoothness compared to the control according to the comparison example (the skyhook control law).

In this manner, according to the first embodiment, the controller 12 includes the calculation processing portion 13, which makes the predetermined calculation based on the input vehicle state amount and outputs the target damping force (the target amount), and the damping force map 16 (the control instruction value acquisition portion), which acquires the control instruction value for controlling the variable damper 6 (the force generation mechanism) based on the above-described target damping force. The calculation processing portion 13 makes the calculation using the learning result that is acquired by causing the DNN 23 to learn the pairs of the plurality of target amounts acquired using the predetermined evaluation method prepared in advance with respect to the plurality of different vehicle state amounts as the pairs of pieces of input and output data. In this case, the learning result is the weight coefficients acquired by the deep learning, which uses the neural network for the learning. Due to this configuration, the controller 12 can change the damping force characteristic according to the driver's preference and/or the required specifications by adjusting the weight coefficients. In addition thereto, the present configuration allows the controller 12 to perform control based on a truly optimal instruction according to each road surface and the vehicle, thereby allowing the controller 12 to improve the ride comfort and the steering stabilization performance.

Further, the calculation processing portion 13 includes the weight coefficient calculation map 14 (the weight coefficient acquisition portion) and the DNN 15 (the instruction value acquisition portion). The plurality of pairs of different weight coefficients Wij_HighGain and Wij_LowGain, which is acquired by applying the deep learning using the plurality of different evaluation function weights q1 and q2, is set to the weight coefficient calculation map 14. The weight coefficient calculation map 14 acquires the specific single pair of weight coefficients Wij based on the plurality of pairs of different weight coefficients Wij_HighGain and Wij_LowGain according to the input predetermined condition. The specific weight coefficients Wij are set to the DNN 15. The DNN 15 makes the calculation using the neural network.

In this case, the weight coefficient calculation map 14 includes the first map 14A, which indicates the relationship between the mode output from the mode switch 17 (the predetermined condition) and the GSP, and the second map 14B, which indicates the relationship between the weight coefficients and the GSP. The weight coefficient calculation map 14 acquires the weight coefficients Wij of the DNN 15 according to the mode of the mode switch 17 corresponding to the input predetermined condition. Due to this configuration, the weight coefficients Wij of the DNN 15 can be changed according to the driver's preference and/or the requirement from the OEM (original equipment manufacturer). As a result, the weight coefficients Wij of the DNN 15 can be easily adjusted and changed on the vehicle side.

Further, the damping force map 16 indicates the relationship between the target damping force serving as the target amount and the instruction value output to the variable damper 6. Therefore, in the case where the optimal instruction value is set as the damping force instruction, even when the damping force characteristic is changed, this can be handled well by updating only the damping force map 16 provided at the subsequent stage to the DNN 15. Therefore, the present configuration allows the controller 12 to deal with the damper characteristic just by the map update of the damping force map 16.

Further, the present configuration allows control to be constructed without complex modeling even for a non-linear control target like a semi-active suspension (the variable damper 6). In light of the calculation time, the present technology cannot allow the direct optimal control to be implemented on the ECU 11 while each road surface, the vehicle, and the characteristic of the variable damper 6 are taken into consideration. However, artificial intelligence (the DNN 15) caused to learn the direct optimal instruction in advance can be implemented on the ECU 11 (the controller 12). Therefore, the direct optimal control can be realized using the ECU 11.

The calculation processing portion 13 further makes the calculation while additionally taking the input road surface information (the road surface profile) into consideration, and makes the calculation using the learning result that is acquired by causing the DNN 15 of the calculation processing portion 13 to learn the pairs of the plurality of target amounts acquired using the predetermined evaluation method prepared in advance with respect to the plurality of different vehicle state amounts and the plurality of different pieces of road surface information as the pairs of pieces of input and output data. At this time, the DNN IS learns the instruction value acquired by the optimization method so as to minimize the evaluation function J in advance, and the vehicle state amount and the road surface profile. As a result, the present configuration allows the controller 12 to perform control based on the truly optimal instruction according to each road surface, thereby allowing the controller 12 to improve the ride comfort and the steering stabilization performance.

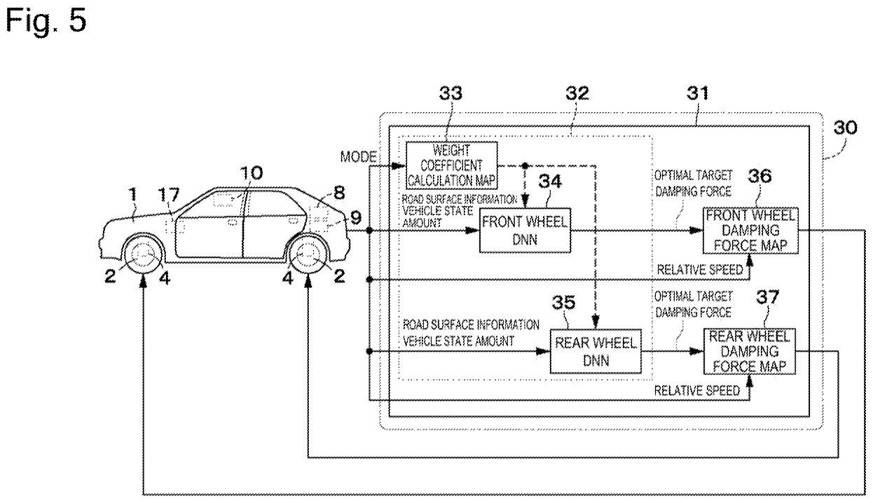

Next. FIG. 5 illustrates a second embodiment. The second embodiment is characterized in that different DNNs are set for the front wheel and the rear wheel, respectively. The second embodiment will be described, indicating similar components to the above-described first embodiment by the same reference numerals and omitting the descriptions thereof.

An ECU 30 according to the second embodiment is configured similarly to the ECU 11 according to the first embodiment. The ECU 30 includes a controller 31. The input side of the ECU 30 is connected to the sprung acceleration sensor 8, the vehicle height sensor 9, the road surface measurement sensor 10, and the mode switch 17. The output side of the ECU 30 is connected to the damping force variable actuator 7 of the variable damper 6. The controller 31 of the ECU 30 acquires the road surface profile and the vehicle state amount based on the detection value of the vertical vibration acceleration by the sprung acceleration sensor 8, the detection value of the vehicle height of the vehicle height sensor 9, and the detection value of the road surface by the road surface measurement sensor 10. The controller 31 calculates the force that should be generated by the variable damper 6 (the force generation mechanism) of the suspension apparatus 4 based on the road surface profile and the vehicle state amount, and outputs the instruction signal thereof to the damping force variable actuator 7 of the suspension apparatus 4.

The controller 31 includes a calculation processing portion 32, a front wheel damping force map 36, and a rear wheel damping force map 37. The calculation processing portion 32 includes a weight coefficient calculation map 33, and an already trained front wheel DNN 34 and rear wheel DNN 35.

The controller 31 includes the calculation processing portion 32, the front wheel damping force map 36, and the rear wheel damping force map 37. The calculation processing portion 32 includes the weight coefficient calculation map 33, and the front wheel DNN 34 and the rear wheel DNN 35.

The weight coefficient calculation map 33 is configured similarly to the weight coefficient calculation map 14 according to the first embodiment. A plurality of pairs of different weight coefficients, which is acquired by applying the deep learning using a plurality of different weights (weights of an evaluation function), is set to the weight coefficient calculation map 33. In this case, the weight coefficients include front wheel weight coefficients and rear wheel weight coefficients. The mode switch 17 is connected to the input side of the weight coefficient calculation map 33. The weight coefficient calculation map 33 acquires a single pair of front wheel weight coefficients specified based on a plurality of pairs of different front wheel weight coefficients according to the mode selected by the mode switch 17. In addition thereto, the weight coefficient calculation map 33 acquires a single pair of rear wheel weight coefficients specified based on a plurality of pairs of different rear wheel weight coefficients according to the mode selected by the mode switch 17.

The front wheel DNN 34 and the rear wheel DNN 35 are included in the instruction value acquisition portion. The front wheel DNN 34 is a front wheel instruction value acquisition portion for the front wheel among the wheels 2. The rear wheel DNN 35 is a rear wheel instruction value acquisition portion for the rear wheel among the wheels 2. The front wheel DNN 34 and the rear wheel DNN 35 are configured similarly to the DNN according to the first embodiment. Therefore, each of the front wheel DNN 34 and the rear wheel DNN 35 is an AI learning portion, and is formed by, for example, a multi-layered neural network including four or more layers. Each layer includes a plurality of neurons, and neurons of two layers adjacent to each other are connected via weight coefficients. The front wheel weight coefficients acquired by the weight coefficient calculation map 33 are set as the weight coefficients of the front wheel DNN 34. The rear wheel weight coefficients acquired by the weight coefficient calculation map 33 are set as the weight coefficients of the rear wheel DNN 35.

The controller 31 acquires the chronological data of the road surface input (the road surface profile) and the chronological data of the vehicle state amount for each of the four wheels separately based on the detection value of the vertical vibration acceleration by the sprung acceleration sensor 8, the detection value of the vehicle height by the vehicle height sensor 9, and the detection value of the road surface by the road surface measurement sensor 10.

At this time, the front wheel DNN 34 outputs chronological data of the target damping force for the front wheel based on the chronological data of the road surface input and the chronological data of the vehicle state amount. The front wheel damping force map 36 outputs an instruction value for the damping force for the front wheel based on the latest target damping force acquired from the front wheel DNN 34 and the relative speed between the sprung side and the unsprung side, which is included in the vehicle state amount. The controller 31 outputs the most appropriate instruction value for the damping force for the present vehicle and road surface to the damping force variable actuator 7 of the variable damper 6 of the front wheel.

Similarly, the rear wheel DNN 35 outputs chronological data of the target damping force for the rear wheel based on the chronological data of the road surface input and the chronological data of the vehicle state amount. The rear wheel damping force map 37 outputs an instruction value for the damping force for the front wheel based on the latest target damping force acquired from the rear wheel DNN 35 and the relative speed between the sprung side and the unsprung side, which is included in the vehicle state amount. The controller 31 outputs the most appropriate instruction value for the damping force for the present vehicle and road surface to the damping force variable actuator 7 of the variable damper 6 of the rear wheel.

In this manner, the second embodiment can also bring about approximately similar advantageous effects to the first embodiment. Further, in the second embodiment, the instruction value acquisition portion includes the front wheel DNN 34 and the rear wheel DNN 35. In this case, the front wheel DNN 34 and the rear wheel DNN 35 are caused to learn optimal instructions different according to the vehicle specifications of the front wheel and the rear wheel, respectively. More specifically, the specifications of the vehicle model used to search for the direct optimal control instruction value are set for each of the front wheel and the rear wheel, and the optimal target damping force (the optimal instruction) is searched for with respect to each of them individually independently. This case doubles the processing of the search for the direct optimal control instruction value. However, this configuration allows the optimal target damping force to be derived according to the vehicle specifications normally different between the front wheel and the rear wheel, thereby contributing to improving, for example, the vibration damping performance.

Next. FIG. 2 illustrates a third embodiment. The third embodiment is characterized in that the vertical acceleration of the vehicle is divided into a low-frequency component and a high-frequency component in the evaluation function for acquiring the optimal control instruction (the target damping force). The third embodiment will be described, indicating similar components to the above-described first embodiment by the same reference numerals and omitting the descriptions thereof.

In the first embodiment, the evaluation function J for the optimization is formed by only the vertical acceleration and the optimal control instruction. On the other hand, in the third embodiment, the vertical acceleration is divided into a low-frequency component and a high-frequency component in the evaluation function J for the optimization. The low-frequency component is, for example, a component in a first frequency region (0.5 to 2 Hz), which is a floating sensation region. The high-frequency component is, for example, a component in a second frequency region (2 to 50 Hz), which is a vibration region other than the floating sensation. As a result, the present configuration makes it possible to specify which is desired to reduce, the low-frequency vibration and the high-frequency signal in the vertical acceleration.

At this time, a direct optimal control portion 40 according to the third embodiment uses the evaluation function J expressed by the following equation 13.

J=∫₀^{t}^{_{f}}(q₁₁Az_{low}²+q₁₂Az_{high}²+q₂u²)dt [Equation 13]

In this equation, q11 represents the weight for the low-frequency vertical vibration, q12 represents the weight for the high-frequency vertical vibration, and q2 represents the weight for the control instruction.

The low-frequency vertical acceleration is calculated using a value acquired by performing low-pass filter processing on the vertical acceleration. The high-frequency vertical acceleration is calculated using a value acquired by performing high-pass filter processing on the vertical acceleration. The evaluation function may be formed using a value acquired by applying a frequency analysis to the vertical acceleration and converting the low-frequency component/high-frequency component into an RMS value (an effective value). The direct optimal control portion 40 may use not only the evaluation function containing the two frequency components, the low-frequency component and the high-frequency component, but also, for example, an evaluation function containing three frequency components, i.e., additionally containing an intermediate-frequency component between the low-frequency component and the high-frequency component, or may use an evaluation function containing four or more frequency components.

In this manner, the third embodiment can also bring about substantially similar advantageous effects to the first embodiment. Further, in the third embodiment, the vertical acceleration of the vehicle is divided into the low-frequency component and the high-frequency component in the evaluation function J. As a result, using such an evaluation function J makes it possible to specify which is desired to reduce, the low-frequency vibration and the high-frequency signal in the vertical acceleration.

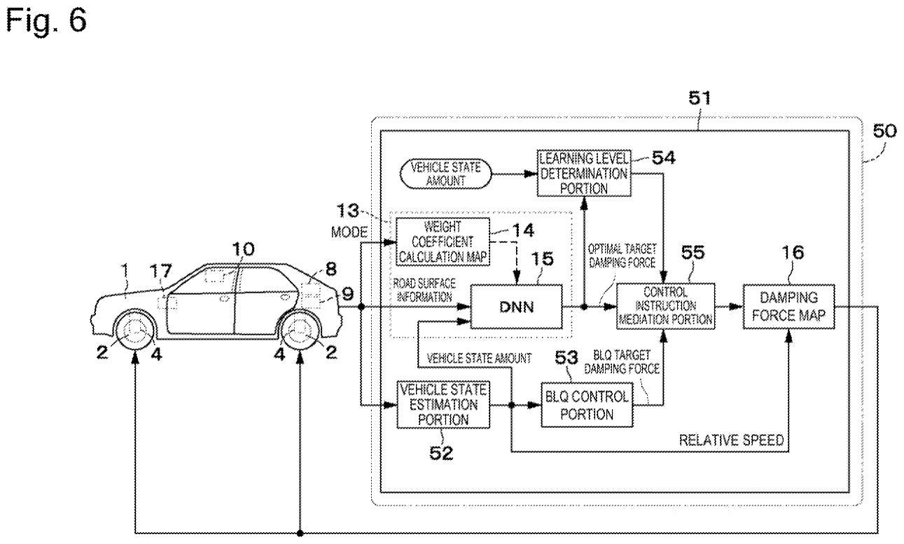

Next, FIG. 6 illustrates a fourth embodiment. The fourth embodiment is characterized in that the controller includes a BLQ control portion, which acquires a target amount for performing feedback control based on the input vehicle state amount, and a control instruction mediation portion, which acquires the target amount to be output to the damping force map based on the target amount acquired by the DNN and the target amount acquired by the BLQ control portion. The fourth embodiment will be described, indicating similar components to the above-described first embodiment by the same reference numerals and omitting the descriptions thereof.

An ECU 50 according to the fourth embodiment is configured similarly to the ECU 11 according to the first embodiment. The ECU 50 includes a controller 51. The input side of the ECU 50 is connected to the sprung acceleration sensor 8, the vehicle height sensor 9, and the road surface measurement sensor 10. The output side of the ECU 50 is connected to the damping force variable actuator 7 of the variable damper 6.

The controller 51 of the ECU 50 acquires the road surface profile based on the detection value of the road surface by the road surface measurement sensor 10. The controller 51 of the ECU 50 includes a vehicle state estimation portion 52, which estimates the vehicle state. The vehicle state estimation portion 52 acquires the vehicle state amount based on, for example, the detection value of the vertical vibration acceleration by the sprung acceleration sensor 8 and the detection value of the vehicle height by the vehicle height sensor 9. The controller 51 calculates the force that should be generated by the variable damper 6 (the force generation mechanism) of the suspension apparatus 4 based on the road surface profile and the vehicle state amount, and outputs an instruction signal thereof to the damping force variable actuator 7 of the suspension apparatus 4.

The controller 51 includes the calculation processing portion 13 and the damping force map 16. The calculation processing portion 13 includes the weight coefficient calculation map 14 and the already trained DNN 15 (the deep neural network). In addition thereto, the controller 51 includes the BLQ control portion 53 and the control instruction mediation portion 55.

A plurality of pairs of different weight coefficients, which is acquired by applying the deep learning using a plurality of different weights (weights of an evaluation function), is set to the weight coefficient calculation map 14. The weight coefficient calculation map 14 acquires a single pair of weight coefficients specified based on the plurality of pairs of different weight coefficients according to the mode selected by the mode switch 17.

The single pair of weight coefficients acquired by the weight coefficient calculation map 14 is set as the weight coefficients of the DNN 15. The road surface profile based on the detection value of the road surface by the road surface measurement sensor 10 is input to the DNN 15, and the vehicle state amount from the vehicle state estimation portion 52 is also input to the DNN 15. At this time, the DNN 15 outputs the optimal target damping force formed by the chronological data based on the chronological data of the road surface input and the chronological data of the vehicle state amount.

The BLQ control portion 53 is a feedback target amount acquisition portion that acquires the target damping force (the target amount) for performing the feedback control based on the input vehicle state amount. In this case, the BLQ control portion 53 is a bilinear optimal control portion. The vehicle state amount output from the vehicle state estimation portion 52 is input to the BLQ control portion 53. The BLQ control portion 53 calculates a target damping force (a BLQ target damping force) for reducing the sprung vertical vibration from the vehicle state amount acquired from the vehicle state estimation portion 52 based on a bilinear optimal control theory. In this case, the BLQ target damping force is a target amount for performing the feedback control based on the input vehicle state amount.

A learning level determination portion 54 determines the learning level of the DNN 15 based on the vehicle state amount. More specifically, the learning level determination portion 54 determines the learning level of the DNN 15 based on the sprung vertical acceleration included in the vehicle state amount. The learning level determination portion 54 includes a first threshold value A and a second threshold value B predetermined according to a result of, for example, a running test of the vehicle. The first threshold value A is a reference value for the sprung vertical acceleration for determining whether the learning level is 100/c. The second threshold value B is a value larger than the first threshold value A. and is a reference value for the sprung vertical acceleration for determining whether the learning level is 0%.

If the sprung vertical acceleration is equal to or lower than the first threshold value A, the reliability can be deemed high, and therefore the learning level determination portion 54 determines that the learning level is 100%. If the sprung vertical acceleration is higher than the first threshold value A and equal to or lower than the second threshold value, the reliability can be deemed approximately intermediate, and therefore the learning level determination portion 54 determines that the learning level is 50%. If the sprung vertical acceleration is equal to or lower than the second threshold value B, the reliability can be deemed low, and therefore the learning level determination portion 54 determines that the learning level is 0%.

The learning level determination portion 54 may determine the learning level in consideration of not only the sprung vertical acceleration but also, for example, the optimal target damping force output from the DNN 15. The learning level determination portion 54 determines the learning level on a scale of three levels, 100%, 50%, and 0%. Without being limited thereto, the learning level determination portion 54 may determine the learning level on a scale of two levels or may determine the learning level on a scale of four or more levels.

The control instruction mediation portion 55 is a mediation portion that acquires the target amount to be output to the damping force map 16 based on the target amount acquired by the DNN 15 and the target amount acquired by the BLQ control portion 53. The learning level output from the learning level determination portion 54, the optimal target damping force (the target amount) output from the DNN 15, and the BLQ target damping force (the target amount) output from the BLQ control portion 53 are input to the control instruction mediation portion 55. The control instruction mediation portion 55 adjusts the optimal target damping force and the BLQ target damping force based on the learning level of the DNN 15, thereby adjusting the target damping force to be output to the damping force map 16.

Basically, when the DNN 15 is already trained, the control performance such as the vibration damping performance of the DNN 15 is higher compared to the BLQ control portion 53. In this case, the control instruction mediation portion 55 outputs the optimal target damping force of the DNN 15 directly, trusting the DNN 15. On the other hand, when being not yet trained or in the middle of being trained, the DNN 15 does not necessarily have to be optimal control. Therefore, the control instruction mediation portion 55 determines the ratio between the instruction of the DNN 15 (the optimal target damping force) and the instruction of the BLQ control portion 53 (the BLQ target damping force) according to the learning level of the DNN 15, and outputs a final instruction (the target damping force) based on these two instructions.

More specifically, the control instruction mediation portion 55 outputs the optimal target damping force of the DNN 15 as the final target damping force when the learning level of the DNN 15 is 100%. The control instruction mediation portion 55 outputs an average value (an arithmetic average) of the optimal target damping force of the DNN 15 and the BLQ target damping force of the BLQ control portion 53 as the final target damping force when the learning level of the DNN 15 is 50%. The control instruction mediation portion 55 outputs the BLQ target damping force of the BLQ control portion 53 as the final target damping force when the learning level of the DNN 15 is 0%.

The damping force map 16 outputs the instruction value for the damping force based on the final target damping force acquired from the control instruction mediation portion 55 and the relative speed between the sprung side and the unsprung side, which is included in the vehicle state amount. The controller 51 outputs the most appropriate instruction value for the damping force for the present vehicle and road surface to the damping force variable actuator 7 of the variable damper 6 of the front wheel.

In this manner, the fourth embodiment can also bring about approximately similar advantageous effects to the first embodiment. Further, in the fourth embodiment, the controller 51 includes the BLQ control portion 53, which acquires the BLQ target damping force for performing the feedback control, and the control instruction mediation portion 55 (a mediation portion), which acquires the target damping force (the target amount) to be output to the damping force map 16 based on the optimal target damping force (the target amount) acquired by the DNN 15 and the BLQ target damping force (the target amount) acquired by the BLQ control portion 53. Due to this configuration, when the DNN 15 is in an untrained state, the controller 51 controls the variable damper 6 based on the BLQ target damping force acquired from the BLQ control portion 53. As a result, the fourth embodiment can secure a similar performance of ride comfort control to the conventional technique using the feedback control. Further, the fourth embodiment allows the controller 51 to also cope with the change in the vehicle specifications by combining the AI control by the DNN 15 and the feedback control by the BLQ control portion 53 on the already learned road surface.

The road surface profile may be stored or transmitted to an external server when the vehicle runs on an unlearned road surface. In this case, the direct optimal control portion acquires the optimal instruction value based on the newly acquired unlearned road surface profile. After that, the weight coefficients between the neurons in the DNN are learned again with the road surface profile and the optimal instruction value added thereto. After the learning is completed, the weight coefficients of the weight coefficient calculation map mounted on the vehicle are updated. As a result, when the vehicle runs on the same road surface, the weight coefficient calculation map sets new weight coefficients based on the updated data to the DNN. Therefore, the damping force of the variable damper 6 can be optimally controlled using the DNN.

Further, the feedback target amount calculation portion may be configured to control the variable damper 6 based on the skyhook control law or may be configured to control the variable damper 6 based on another control law such as the H∞ control without being limited to the BLQ control (the bilinear optimal control).

The above-described first and second embodiments have been described, assuming that the vehicle state amount acquisition portion includes the sprung acceleration sensor 8 and the vehicle height sensor 9. The present invention is not limited thereto, and the vehicle state amount acquisition portion may include, for example, a portion that calculates the vehicle state amount based on the detection value of the vertical vibration acceleration by the sprung acceleration sensor 8 and the detection value of the vehicle height by the vehicle height sensor 9, in addition to the sprung acceleration sensor 8 and the vehicle height sensor 9. Alternatively, the vehicle state amount acquisition portion may acquire information regarding the vehicle state amount such as the vehicle speed in addition to the detection signals from the sprung acceleration sensor and the vehicle height sensor based on a signal from a CAN (Controller Area Network), and calculate or estimate the vehicle state amount in consideration of these pieces of information. In this case, the vehicle state amount acquisition portion includes a calculation portion in the ECU 11 or 30 in addition to the various kinds of sensors.

Each of the above-described embodiments has been described, assuming that the calculation processing portions 13 and 32 include the neural network. The present invention is not limited thereto, and the calculation processing portion may include no neural network as long as it can learn the pairs of the plurality of target amounts with respect to the plurality of different vehicle state amounts as the pairs of pieces of input and output data.

In each of the above-described embodiments, the road surface profile acquisition portion detects the road surface profile by the road surface measurement sensor 10. The present invention is not limited thereto, and, for example, the road surface profile acquisition portion may be configured to acquire information from a server based on GPS data or may be configured to acquire information from another vehicle via inter-vehicle communication. Alternatively, the road surface profile acquisition portion may estimate the road surface information (the road surface profile) based on the detection value of the vertical vibration acceleration by the sprung acceleration sensor 8 and the detection value of the vehicle height by the vehicle height sensor 9. In this case, the road surface profile acquisition portion includes the calculation portion in the ECU 11, 30 or 50 in addition to the various kinds of sensors.

Each of the above-described embodiments has been described, assuming that the calculation processing portions 13 and 32 calculate the target amount (the target damping force) based on the vehicle state amount and the road surface information (the road surface profile). The present invention is not limited thereto, and the calculation processing portion may calculate the target amount only based on the vehicle state amount without taking the road surface information into consideration. In this case, the calculation processing portion makes the above-described calculation using the learning result that is acquired by causing the above-described calculation processing portion to learn the pairs of the plurality of target amounts acquired using the predetermined evaluation method prepared in advance with respect to the plurality of different vehicle state amounts as the pairs of pieces of input and output data.

The target damping force is used as the target amount in each of the above-described embodiments, but a target damping coefficient may be used. In this case, the control instruction value acquisition portion acquires the control instruction value for the variable damper 6 based on the target damping coefficient.

Each of the above-described embodiments has been described, assuming that the vehicle is equipped with the mode switch 17 that inputs the mode as the predetermined condition to the weight coefficient calculation map 14 or 33. The present invention is not limited thereto, and, for example, the predetermined condition may be input to the weight coefficient calculation map from an external mobile terminal at the time of maintenance of the vehicle.

Each of the above-described embodiments has been described, citing the example in which the force generation mechanism is the variable damper 6 realized by a semi-active damper. However, the present invention is not limited thereto, and may be configured in such a manner that an active damper (any of an electric actuator and a hydraulic actuator) is used as the force generation mechanism. Each of the above-described embodiments has been described, citing the example in which the force generation mechanism that generates the adjustable force between the vehicle body 1 side and the wheel 2 side is embodied by the variable damper 6 realized by a damping force adjustable hydraulic shock absorber. The present invention is not limited thereto, and, for example, the force generation mechanism may be embodied by an air suspension, a stabilizer (a kinetic suspension), an electromagnetic suspension, or the like besides the hydraulic shock absorber.

Each of the embodiments has been described citing the vehicle behavior apparatus used together with the four-wheeled automobile by way of example. However, the present invention is not limited thereto, and can also be applied to, for example, a two-wheeled or three-wheeled automobile, or a truck, bus, or the like working as a service vehicle or a transporter vehicle.

Each of the above-described embodiments is only an example, and the configurations indicated in the different embodiments can be partially replaced or combined.

Next, the vehicle control apparatus, the vehicle control method, and the vehicle control system included in the above-described embodiments can have, for example, the following configurations.

A first configuration is a vehicle control apparatus employed for a vehicle including a force generation mechanism configured to adjust a force between a vehicle body of the vehicle and a wheel of the vehicle. The vehicle control apparatus includes a calculation processing portion configured to make a predetermined calculation based on an input vehicle state amount and output a target amount, and a control instruction value acquisition portion configured to acquire a control instruction value for controlling the force generation mechanism based on the target amount. The calculation processing portion makes the calculation using a learning result that is acquired by causing the calculation processing portion to learn pairs of a plurality of target amounts acquired using a predetermined evaluation method prepared in advance with respect to a plurality of different vehicle state amounts as pairs of pieces of input and output data.

As a second configuration, in the first configuration, the learning result is a weight coefficient acquired by deep learning, which uses a neural network for the learning.

As a third configuration, in the second configuration, the calculation processing portion includes a weight coefficient acquisition portion configured in such a manner that a plurality of different weight coefficients acquired by applying the deep learning using a plurality of different weights is set thereto. The weight coefficient acquisition portion is configured to acquire a specific weight coefficient among the plurality of different weight coefficients according to an input predetermined condition. The calculation processing portion further includes an instruction value acquisition portion configured in such a manner that the specific weight coefficient is set thereto. The calculation processing portion is configured to make the calculation that uses the neural network for learning.

As a fourth configuration, in the third configuration, the weight coefficient acquisition portion includes a first map indicating a relationship between the predetermined condition output from a mode switch and a gain scheduling parameter, and a second map indicating a relationship between the weight coefficient and the gain scheduling parameter.

As a fifth configuration, in the third configuration, the target amount is a target damping force. The control instruction value acquisition portion is a damping force map indicating a relationship between the target damping force and an instruction value to be output to the force generation mechanism.

As a sixth configuration, in the third configuration, the instruction value acquisition portion includes a front wheel instruction value acquisition portion for a front wheel included in the wheel, and a rear wheel instruction value acquisition portion for a rear wheel included in the wheel.

As a seventh configuration, in the third configuration, the vehicle control apparatus further includes a feedback target amount acquisition portion configured to acquire a target amount for performing feedback control based on the input vehicle state amount, and a mediation portion configured to acquire the target amount to be output to the control instruction value acquisition portion based on the target amount acquired by the instruction value acquisition portion and the target amount acquired by the feedback target amount acquisition portion.

As an eighth configuration, in the first configuration, the predetermined evaluation method includes an evaluation function. The evaluation function includes a configuration in which a vertical acceleration of the vehicle is divided into a low-frequency component and a high-frequency component.

As a ninth configuration, in the first configuration, the target amount is a target damping force. The control instruction value acquisition portion is a damping force map indicating a relationship between the target damping force and an instruction value to be output to the force generation mechanism.

As a tenth configuration, in the first configuration, the calculation processing portion is configured to further make the calculation while additionally taking input road surface information (a road surface profile) into consideration. The calculation processing portion makes the calculation using a learning result that is acquired by causing the calculation processing portion to learn pairs of a plurality of target amounts acquired using the predetermined evaluation method prepared in advance with respect to the plurality of different vehicle state amounts and a plurality of different pieces of road surface information as pairs of pieces of input and output data.

An eleventh configuration is a vehicle control method employed for a vehicle including a force generation mechanism configured to adjust a force between a vehicle body of the vehicle and a wheel of the vehicle. The vehicle control method includes a calculation processing step of making a predetermined calculation based on an input vehicle state amount and outputting a target amount, and a control instruction value acquisition step of acquiring a control instruction value for controlling the force generation mechanism based on the target amount. The calculation processing step includes making the calculation using a learning result that is acquired by causing a calculation processing portion to learn pairs of a plurality of target amounts acquired using a predetermined evaluation method prepared in advance with respect to a plurality of different vehicle state amounts as pairs of pieces of input and output data.

As a twelfth configuration, a vehicle control system includes a force generation mechanism configured to adjust a force between a vehicle body of a vehicle and a wheel of the vehicle, and a controller. The controller includes a calculation processing portion configured to make a predetermined calculation based on an input vehicle state amount and output a target amount, and a control instruction value acquisition portion configured to acquire a control instruction value for controlling the force generation mechanism based on the target amount. The calculation processing portion is configured to make the calculation using a learning result that is acquired by causing the calculation processing portion to learn pairs of a plurality of target amounts acquired using a predetermined evaluation method prepared in advance with respect to a plurality of different vehicle state amounts as pairs of pieces of input and output data.

The present invention shall not be limited to the above-described embodiments, and includes various modifications. For example, the above-described embodiments have been described in detail to facilitate a better understanding of the present invention, and the present invention shall not necessarily be limited to the configuration including all of the described features. Further, a part of the configuration of some embodiment can be replaced with the configuration of another embodiment. Further, some embodiment can also be implemented with a configuration of another embodiment added to the configuration of this embodiment. Further, each embodiment can also be implemented with another configuration added, deleted, or replaced with respect to a part of the configuration of this embodiment.

The present application claims priority under the Paris Convention to Japanese Patent Application No. 2020-047947 filed on Mar. 18, 2020. The entire disclosure of Japanese Patent Application No. 2020-047947 filed on Mar. 18, 2020 including the specification, the claims, the drawings, and the abstract is incorporated herein by reference in its entirety.

### REFERENCE SIGNS LIST

1 vehicle body
2 wheel
3 tire
4 suspension apparatus
5 suspension spring (spring)
6 variable damper (force generation mechanism)
7 damping force variable actuator
8 sprung acceleration sensor
9 vehicle height sensor
10 road surface measurement sensor
11, 30, 50 ECU
12, 31, 51 controller (vehicle control apparatus)
13, 32 calculation processing portion
14, 33 weight coefficient calculation map (weight coefficient acquisition portion)
14A first map
14B second map
15 DNN (instruction value acquisition portion)
16 damping force map (control instruction value acquisition portion)
17 mode switch
22, 40 direct optimal control portion
34 front wheel DNN (front wheel instruction value acquisition portion)
35 rear wheel DNN (rear wheel instruction value acquisition portion)
36 front wheel damping force map (control instruction value acquisition portion)
37 rear wheel damping force map (control instruction value acquisition portion)
52 vehicle state estimation portion
53 BLQ control portion (feedback target amount acquisition portion)
54 learning level determination portion
55 control instruction mediation portion (mediation portion)

1-12. (canceled)

13. A vehicle control apparatus employed for a vehicle including a force generation mechanism configured to adjust a force between a vehicle body of the vehicle and a wheel of the vehicle, the vehicle control apparatus comprising:
a calculation processing portion configured to make a predetermined calculation based on an input vehicle state amount and output a target amount; and
a control instruction value acquisition portion configured to acquire a control instruction value for controlling the force generation mechanism based on the target amount,
wherein the calculation processing portion makes the calculation using a learning result that is acquired by causing the calculation processing portion to learn pairs of a plurality of target amounts acquired using a predetermined evaluation method prepared in advance with respect to a plurality of different vehicle state amounts as pairs of pieces of input and output data,
wherein the learning result is a weight coefficient acquired by deep learning, which uses a neural network for the learning,
wherein the calculation processing portion includes
a weight coefficient acquisition portion configured in such a manner that a plurality of different weight coefficients acquired by applying the deep learning using a plurality of different weights is set thereto, the weight coefficient acquisition portion being configured to acquire a specific weight coefficient among the plurality of different weight coefficients according to an input predetermined condition, and
an instruction value acquisition portion configured in such a manner that the specific weight coefficient is set thereto, the instruction value acquisition portion being configured to make the calculation that uses the neural network for learning, and
wherein the weight coefficient acquisition portion includes
a first map indicating a relationship between the predetermined condition output from a mode switch and a gain scheduling parameter, and
a second map indicating a relationship between the weight coefficient and the gain scheduling parameter.

14. A vehicle control apparatus employed for a vehicle including a force generation mechanism configured to adjust a force between a vehicle body of the vehicle and a wheel of the vehicle, the vehicle control apparatus comprising:
a calculation processing portion configured to make a predetermined calculation based on an input vehicle state amount and output a target amount; and
a control instruction value acquisition portion configured to acquire a control instruction value for controlling the force generation mechanism based on the target amount,
wherein the calculation processing portion makes the calculation using a learning result that is acquired by causing the calculation processing portion to learn pairs of a plurality of target amounts acquired using a predetermined evaluation method prepared in advance with respect to a plurality of different vehicle state amounts as pairs of pieces of input and output data,
wherein the learning result is a weight coefficient acquired by deep learning, which uses a neural network for the learning,
wherein the calculation processing portion includes
a weight coefficient acquisition portion configured in such a manner that a plurality of different weight coefficients acquired by applying the deep learning using a plurality of different weights is set thereto, the weight coefficient acquisition portion being configured to acquire a specific weight coefficient among the plurality of different weight coefficients according to an input predetermined condition, and
an instruction value acquisition portion configured in such a manner that the specific weight coefficient is set thereto, the instruction value acquisition portion being configured to make the calculation that uses the neural network for learning,
wherein the target amount is a target damping force, and
wherein the control instruction value acquisition portion is a damping force map indicating a relationship between the target damping force and an instruction value to be output to the force generation mechanism.

15. A vehicle control apparatus employed for a vehicle including a force generation mechanism configured to adjust a force between a vehicle body of the vehicle and a wheel of the vehicle, the vehicle control apparatus comprising:
a calculation processing portion configured to make a predetermined calculation based on an input vehicle state amount and output a target amount; and
a control instruction value acquisition portion configured to acquire a control instruction value for controlling the force generation mechanism based on the target amount,
wherein the calculation processing portion makes the calculation using a learning result that is acquired by causing the calculation processing portion to learn pairs of a plurality of target amounts acquired using a predetermined evaluation method prepared in advance with respect to a plurality of different vehicle state amounts as pairs of pieces of input and output data,
wherein the learning result is a weight coefficient acquired by deep learning, which uses a neural network for the learning,
wherein the calculation processing portion includes
a weight coefficient acquisition portion configured in such a manner that a plurality of different weight coefficients acquired by applying the deep learning using a plurality of different weights is set thereto, the weight coefficient acquisition portion being configured to acquire a specific weight coefficient among the plurality of different weight coefficients according to an input predetermined condition, and
an instruction value acquisition portion configured in such a manner that the specific weight coefficient is set thereto, the instruction value acquisition portion being configured to make the calculation that uses the neural network for learning, and
wherein the instruction value acquisition portion includes
a front wheel instruction value acquisition portion for a front wheel included in the wheel, and
a rear wheel instruction value acquisition portion for a rear wheel included in the wheel.

16. A vehicle control apparatus employed for a vehicle including a force generation mechanism configured to adjust a force between a vehicle body of the vehicle and a wheel of the vehicle, the vehicle control apparatus comprising:
a calculation processing portion configured to make a predetermined calculation based on an input vehicle state amount and output a target amount; and
a control instruction value acquisition portion configured to acquire a control instruction value for controlling the force generation mechanism based on the target amount,
wherein the calculation processing portion makes the calculation using a learning result that is acquired by causing the calculation processing portion to learn pairs of a plurality of target amounts acquired using a predetermined evaluation method prepared in advance with respect to a plurality of different vehicle state amounts as pairs of pieces of input and output data,
wherein the learning result is a weight coefficient acquired by deep learning, which uses a neural network for the learning, and
wherein the calculation processing portion includes
a weight coefficient acquisition portion configured in such a manner that a plurality of different weight coefficients acquired by applying the deep learning using a plurality of different weights is set thereto, the weight coefficient acquisition portion being configured to acquire a specific weight coefficient among the plurality of different weight coefficients according to an input predetermined condition, and
an instruction value acquisition portion configured in such a manner that the specific weight coefficient is set thereto, the instruction value acquisition portion being configured to make the calculation that uses the neural network for learning,
further comprising:
a feedback target amount acquisition portion configured to acquire a target amount for performing feedback control based on the input vehicle state amount; and
a mediation portion configured to acquire the target amount to be output to the control instruction value acquisition portion based on the target amount acquired by the instruction value acquisition portion and the target amount acquired by the feedback target amount acquisition portion.

17. A vehicle control apparatus employed for a vehicle including a force generation mechanism configured to adjust a force between a vehicle body of the vehicle and a wheel of the vehicle, the vehicle control apparatus comprising:
a calculation processing portion configured to make a predetermined calculation based on an input vehicle state amount and output a target amount; and
a control instruction value acquisition portion configured to acquire a control instruction value for controlling the force generation mechanism based on the target amount,
wherein the calculation processing portion makes the calculation using a learning result that is acquired by causing the calculation processing portion to learn pairs of a plurality of target amounts acquired using a predetermined evaluation method prepared in advance with respect to a plurality of different vehicle state amounts as pairs of pieces of input and output data,
wherein the predetermined evaluation method includes an evaluation function, and
wherein the evaluation function includes a configuration in which a vertical acceleration of the vehicle is divided into a low-frequency component and a high-frequency component.

18. The vehicle control apparatus according to claim 17, wherein the target amount is a target damping force, and
wherein the control instruction value acquisition portion is a damping force map indicating a relationship between the target damping force and an instruction value to be output to the force generation mechanism.

19. The vehicle control apparatus according to claim 17, wherein the calculation processing portion is configured to further make the calculation while additionally taking input road surface information into consideration, and
wherein the calculation processing portion makes the calculation using a learning result that is acquired by causing the calculation processing portion to learn pairs of a plurality of target amounts acquired using the predetermined evaluation method prepared in advance with respect to the plurality of different vehicle state amounts and a plurality of different pieces of road surface information as pairs of pieces of input and output data.

20. A vehicle control method employed for a vehicle including a force generation mechanism configured to adjust a force between a vehicle body of the vehicle and a wheel of the vehicle, the vehicle control method comprising:
a calculation processing step of making a predetermined calculation based on an input vehicle state amount and outputting a target amount; and
a control instruction value acquisition step of acquiring a control instruction value for controlling the force generation mechanism based on the target amount,
wherein the calculation processing step includes making the calculation using a learning result that is acquired by causing a calculation processing portion to learn pairs of a plurality of target amounts acquired using a predetermined evaluation method prepared in advance with respect to a plurality of different vehicle state amounts as pairs of pieces of input and output data,
wherein the learning result is a weight coefficient acquired by deep learning, which uses a neural network for the learning, and
wherein the calculation processing portion includes
a weight coefficient acquisition portion configured in such a manner that a plurality of different weight coefficients acquired by applying the deep learning using a plurality of different weights is set thereto, the weight coefficient acquisition portion being configured to acquire a specific weight coefficient among the plurality of different weight coefficients according to an input predetermined condition, and
an instruction value acquisition portion configured in such a manner that the specific weight coefficient is set thereto, the instruction value acquisition portion being configured to make the calculation that uses the neural network for learning.
